(19) United States
(12) Patent Application Publication
(10) Pub. No.: US 2022/0038487 A1
(43) Pub. Date: Feb. 3, 2022

(54) METHOD AND SYSTEM FOR A SECURITY ASSESSMENT OF PHYSICAL ASSETS USING PHYSICAL ASSET STATE INFORMATION

(71) Applicant: EMC IP Holding Company LLC, Hopkinton, MA (US)

(72) Inventors: Ruchika Mehresh, Wayland, MA (US); Xuan Tang, Hopkinton, MA (US)

(21) Appl. No.: 16/944,233

(22) Filed: Jul. 31, 2020

(51) Int. Cl. H04L 29/06

(52) U.S. Cl. CPC H04L 63/1433; H04L 63/1416; H04L 63/12; H04L 63/20; H04L 63/1466

(57) ABSTRACT

A method for managing physical assets includes obtaining a physical asset security assessment request for a set of physical assets, and, in response to the physical asset security assessment request: sending a physical asset initiation request to an administrative client, obtaining a physical asset response from the administrative client, wherein the physical asset response comprises physical asset state information, allocating a security assessment device from a security assessment pool based on the physical asset state information, sending a security assessment process request to the security assessment device, wherein the security assessment process request comprises a security assessment process, the physical asset state information and physical asset information obtained from a physical asset information repository, obtaining a security assessment report from the security assessment device, and after obtaining the security assessment report, sending the security assessment report to the administrative client.

### BACKGROUND

Systems may include multiple computing devices. Each computing device may include computing resources. The computing resources utilized by an administrative client may be subject to security risks caused by misuse by the administrative client, malicious entities performing cyberattacks, damage to hardware in the computing devices caused by natural phenomenon, and/or any combination thereof.

### SUMMARY

In general, in one aspect, the invention relates to a method for managing physical assets. The method includes obtaining, by a security assessment coordination manager, a physical asset security assessment request for a set of physical assets, in response to the physical asset security assessment request: sending a physical asset initiation request to an administrative client, obtaining a physical asset response from the administrative client, wherein the physical asset response comprises physical asset state information, allocating a security assessment device from a security assessment pool based on the physical asset state information, sending a security assessment process request to the security assessment device, wherein the security assessment process request comprises a security assessment process, the physical asset state information and physical asset information obtained from a physical asset information repository, obtaining a security assessment report from the security assessment device, and after obtaining the security assessment report, sending the security assessment report to the administrative client, wherein the administrative client initiates a security action on at least a physical asset of the set of physical assets based on the security assessment report.

In general, in one aspect, the invention relates to a non-transitory computer readable medium comprising computer readable program code, which when executed by a computer processor enables the computer processor to perform a method. The method includes obtaining, by a security assessment coordination manager, a physical asset security assessment request for a set of physical assets, in response to the physical asset security assessment request: sending a physical asset initiation request to an administrative client, obtaining a physical asset response from the administrative client, wherein the physical asset response comprises physical asset state information, allocating a security assessment device from a security assessment pool based on the physical asset state information, sending a security assessment process request to the security assessment device, wherein the security assessment process request comprises a security assessment process, the physical asset state information and physical asset information obtained from a physical asset information repository, obtaining a security assessment report from the security assessment device, and after obtaining the security assessment report, sending the security assessment report to the administrative client, wherein the administrative client initiates a security action on at least a physical asset of the set of physical assets based on the security assessment report.

In general, in one aspect, the invention relates to a system that includes a processor and memory that includes instructions which, when executed by the processor, perform a method. The method includes obtaining, by a security assessment coordination manager, a physical asset security assessment request for a set of physical assets, in response to the physical asset security assessment request: sending a physical asset initiation request to an administrative client, obtaining a physical asset response from the administrative client, wherein the physical asset response comprises physical asset state information, allocating a security assessment device from a security assessment pool based on the physical asset state information, sending a security assessment process request to the security assessment device, wherein the security assessment process request comprises a security assessment process, the physical asset state information and physical asset information obtained from a physical asset information repository, obtaining a security assessment report from the security assessment device, and after obtaining the security assessment report, sending the security assessment report to the administrative client, wherein the administrative client initiates a security action on at least a physical asset of the set of physical assets based on the security assessment report.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a security assessment device in accordance with one or more embodiments of the invention.

FIG. 3A shows a flowchart for servicing physical asset security assessment requests in accordance with one or more embodiments of the invention.

FIG. 3B shows a flowchart for performing a security assessment process in accordance with one or more embodiments of the invention.

FIGS. 4A-4B show an example in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for managing computing device resources. Specifically, embodiments of the invention relate to a system that enables an administrative client to utilize computing resources in a secondary environment to assess the security risk of physical assets utilized by the administrative client. Embodiments of the invention may include managing a security assessment pool of computing resources that execute a security assessment process for a set of one or more physical assets. A security assessment coordination manager may communicate with the administrative client (which may be an administrative client from the set of physical assets) and obtain information regarding the physical assets from: (i) the administrative client, and (ii) a physical asset information repository that specifies physical asset information provided by the manufacturer of the physical assets.

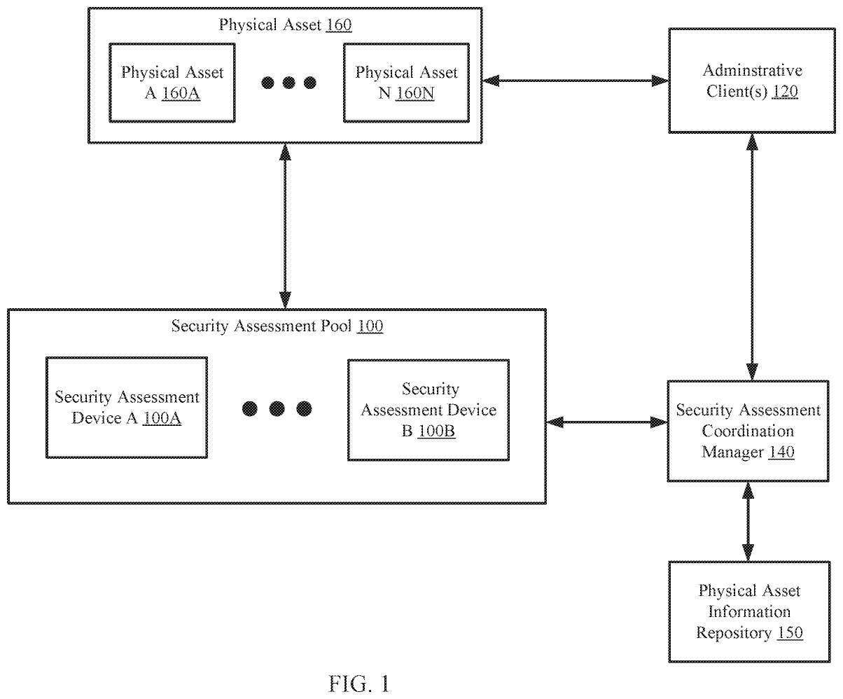

FIG. 1 shows a diagram of a system in accordance with one or more embodiments of the invention. The system includes a security assessment pool (100), one or more administrative clients (120), a security assessment coordination manager (140), a physical asset information repository (150), and one or more physical asset (160). Each component of the system may be operably connected via any combination of wired and/or wireless connections. The system may include additional, fewer, and/or different components without departing from the invention. Each component of the system illustrated in FIG. 1 is discussed below.

In one or more embodiments of the invention, the security assessment pool (100) is a logical grouping of security assessment devices (100A, 100B), each of which may obtain data, store data, provide data, and/or execute applications for the administrative client(s) (120). Each security assessment device (100A, 100N) may include functionality for performing any security assessment processes of the physical asset(s) (160). The security assessment processes may be a series of tasks performed on the security assessment devices designed to assess the security risk of the physical assets.

The security assessment devices (100A, 100B) on which the security assessment process is executing may be imitations (e.g., physical or virtual imitations) of the physical assets. In other words, the security assessment devices (100A, 100B) maybe generated and/or otherwise prepared to match characteristics of the set of physical assets being assessed. The characteristics may be based on information obtained from the security assessment coordination manager (140). The information may be physical asset information (discussed below with the physical asset information repository (150)) and/or physical asset state information obtained from the administrative client (120). Collectively, the physical asset information and the physical asset state information may specify the characteristics of the physical asset that the security coordination device (100A, 100B) imitate.

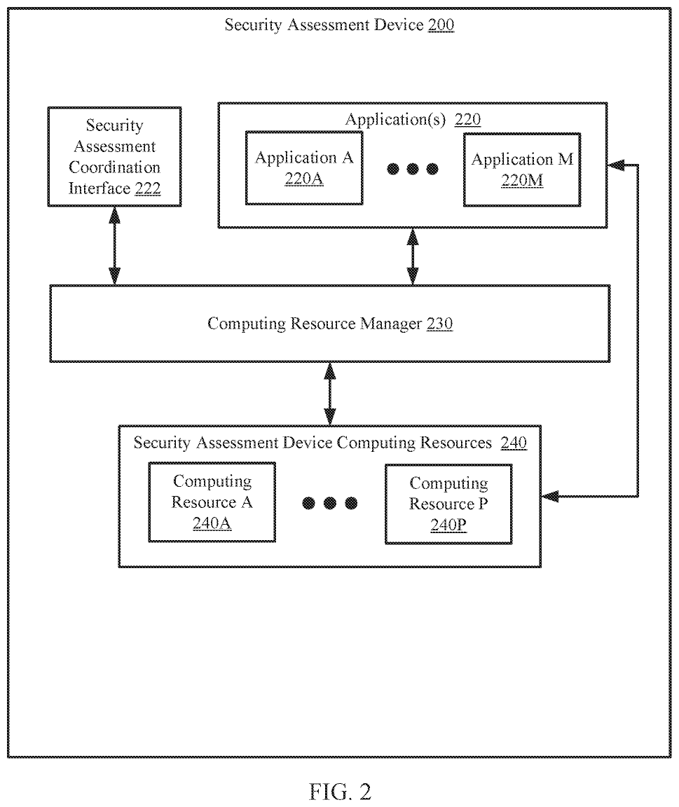

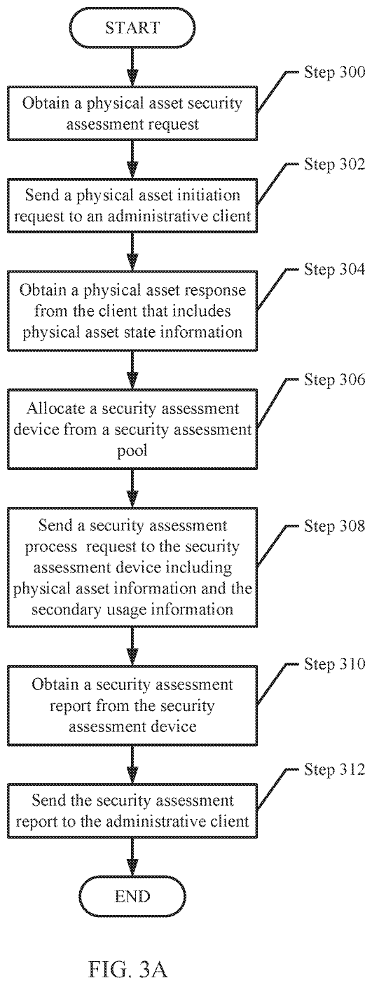

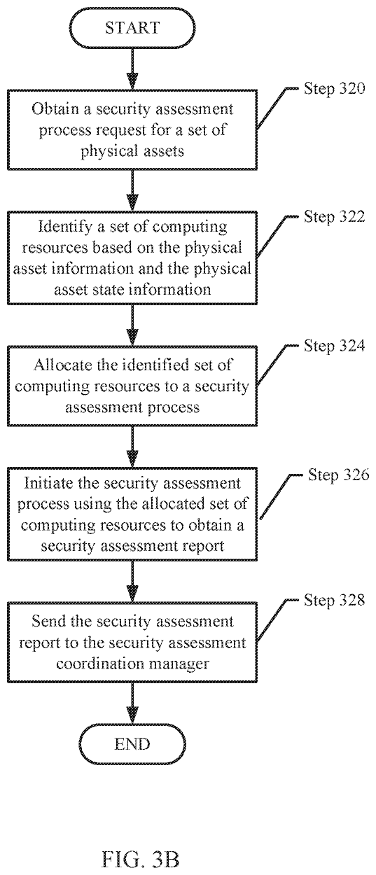

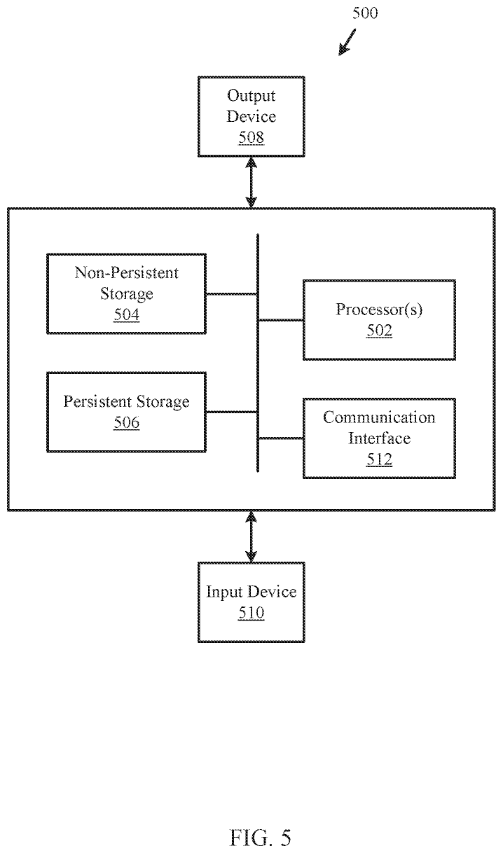

In one or more embodiments of the invention, each security assessment device (100A, 100B) is implemented as a computing device (see, e.g., FIG. 5). A computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the security assessment device (100A, 100B) described throughout this application and/or all, or portion, of the method illustrated in FIG. 3B. For additional details regarding a security assessment device (100A, 100B), see, e.g., FIG. 2.

Each security assessment device (100A, 100B) may be implemented as a logical device without departing from the invention. The logical device utilizes computing resources of any number of physical computing devices to provide the functionality of the security assessment device (e.g., 100A, 100B) described throughout this application and/or all, or portion, of the methods illustrated in FIG. 3B.

In one or more embodiments of the invention, the administrative client(s) (120) utilize the services of the security assessment coordination manager (140) and/or the security assessment pool (100). Specifically, the administrative client(s) (120) sends physical asset security assessment requests to the security assessment coordination manager (140) that specifies one or more physical assets (e.g., 160A) to be assessed. The administrative clients (120) may further communicate with the security assessment coordination manger (140) by providing physical asset state information associated with the physical assets being assessed.

In one or more embodiments of the invention, the physical asset state information may include information associated with the format, operation, deployment, and/or usage of the physical assets by the administrative clients (120) and/or other entities utilizing the physical assets. For example, the physical asset state information may specify the applications, operating systems, and/or other software being executed in a set of one or more physical asset (160A, 160N). Further, the physical asset statute information may specify data traffic usage, data storage usage, networking configuration between the sets of physical assets, database sizes and/or content, and processing usage (e.g., usage of a central processing unit (CPU) at various points in time). The physical asset state information may specify additional, fewer, and/or different information without departing from the invention.

In one or more embodiments of the invention, each administrative client (120) is implemented as a computing device (see, e.g., FIG. 5). The computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the administrative client(s) (120) described throughout this application.

In one or more embodiments of the invention, the administrative client(s) (120) are implemented as a logical device(s). Each logical device may utilize computing resources of any number of physical computing devices to provide the functionality of the administrative client (120) described throughout this application.

In one or more embodiments of the invention, the security assessment coordination manager (140) manages the computing resource use of the security assessment devices (100A, 100B) of the security assessment pool (100). In one or more embodiments of the invention, the security assessment coordination manager (140) manages the security assessment device resources by performing the method of FIG. 3A to prepare the security assessment devices (100A, 100B) for security assessment processes. The security assessment coordination manager (140) further includes functionality for obtaining requested information from the administrative clients (120), the physical asset information repository (150), and/or any other entity. The obtained information may be used to prepare the security assessment devices (100A, 100B) for the security assessment processes.

In one or more embodiments of the invention, the security assessment coordination manager (140) is implemented as a computing device (see, e.g., FIG. 5). The computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the security assessment coordination manager (140) described in this application and/or all, or portion, of the methods illustrated in FIG. 3A.

The security assessment coordination manager (140) may be implemented as a logical device(s) without departing from the invention. The logical device(s) utilizes security assessment device resources of any number of physical computing devices to provide the functionality of the security assessment coordination manager (140) described throughout this application and/or all, or portion, of the methods illustrated in FIGS. 3A-3B.

In one or more embodiments of the invention, the physical asset information repository (150) stores physical asset information associated with the physical assets (160). In one or more embodiments of the invention, physical asset information includes information of one or more physical assets that may not be publicly available. In other words, at least a portion of the physical asset information may only be obtained from the manufacturer of the physical assets. The information may include, for example, initial configuration information, maximum computing capacity, maximum storage capacity, software and/or firmware installed in the physical assets during manufacturing, and/or any other information without departing from the invention

In one or more embodiments of the invention, the physical asset information repository (150) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device cause the computing device to perform the functionality of the physical asset information repository (150) described throughout this application.

In one or more embodiments of the invention, the physical asset information repository (150) is implemented as a logical device(s). The logical device(s) may utilize the computing resources of any number of computing devices and thereby provide the functionality of the physical asset information repository (150) described throughout this application.

In one or more embodiments of the invention, the physical assets (160A, 160N) are computing devices desired by the administrative clients (120) for utilization. The physical assets (160) may be prepared and/or otherwise equipped to perform various functionalities as requested by the administrative clients (120).

Each physical asset (160A, 160N) may be equipped with a usage agent (not shown) that tracks usage of computing resources in the physical asset (160A, 160N). The usage agent may provide the usage as physical asset state information to the corresponding administrative clients (120).

In one or more embodiments of the invention, each physical asset (160A, 160N) is implemented as a computing device (see, e.g., FIG. 5). A computing device may be, for example, a mobile phone, tablet computer, laptop computer, desktop computer, server, or cloud resource. The computing device may include one or more processors, memory (e.g., random access memory), and persistent storage (e.g., disk drives, solid state drives, etc.). The persistent storage may store computer instructions, e.g., computer code, that when executed by the processor(s) of the computing device cause the computing device to perform the functions of the physical asset (160A, 160N) described throughout this application.

The invention is not limited to the architecture shown in FIG. 1.

FIG. 2 shows a diagram of a security assessment device in accordance with one or more embodiments of the invention. The security assessment device (200) may be an embodiment of a security assessment device (100A, 100B, FIG. 1) discussed above. As discussed above, the security assessment device (200) is an imitation of a set of one or more computing resources of a set of physical assets. The security assessment device resources may include applications (220A, 220M), a computing resource manager (230), a security assessment coordination interface (222), and computing resources (240A, 240P). The security assessment device (200) may include additional, fewer, and/or different components without departing from the invention. Each of the aforementioned components is discussed below.

In one or more embodiments of the invention, the applications (220) perform services similar to the applications of the physical assets being imitated. The applications (220A, 220M) may include functionality for providing services to clients (not shown). The services may include writing, reading, and/or otherwise modifying data that is stored in the security assessment device (200). The applications (220A, 220M) may each include functionality for writing data to the security assessment device (200) (e.g., using the security assessment computing resources (240)). The applications may be, for example, instances of databases, email servers, and/or other applications. The applications (220A, 220M) may host other types of applications without departing from the invention.

In one or more of embodiments of the invention, each application (220A, 220M) is implemented as computer instructions, e.g., computer code, stored on a persistent storage that when executed by a processor(s) the security assessment device (200) cause the security assessment device (200) to provide the functionality of the applications (220A, 220M) described throughout this application.

In one or more embodiments of the invention, each application (220A, 220M) is implemented as computing code stored on a persistent storage (e.g., 230) that when executed by a processor (e.g., 240A, 240P) of the security assessment device (200) performs the functionality of the application (220A, 220M). The processor may be a hardware processor including circuitry such as, for example, a central processing unit or a microcontroller. The processor may be other types of hardware devices for processing digital information without departing from the invention.

In one or more embodiments of the invention, the security assessment device (200) includes a computing resource manager (230) that includes functionality for managing the security assessment implemented on the security assessment device. Specifically, the computing resource manager (230) performs a security assessment process on the computing resources to assess the security risk of the security assessment device (200). As discussed above, the security assessment process may include initiating a series of tasks designed to assess the strength of the security system in place for the computing resources (240A, 240P). Examples of tasks performed in the security assessment process include, but are not limited to: a network penetration test, a data package management test, a scanning of the operating system, an application auditing of the applications (220) (or other entities in the security assessment device (200)), a network access test, a vulnerability assessment of each application (220A, 220M) or computing resource (240A, 240P), and a security scanning

In one or more embodiments of the invention, the computing resource manager (230) is implemented as computing code stored on a persistent storage that when executed by a processor of the security assessment device (200) performs the functionality of the computing resource manager (230) described throughout this application and/or all, or a portion thereof, of the method illustrated in FIG. 3B. The processor (not shown) may be a hardware processor including circuitry such as, for example, a central processing unit or a microcontroller. The processor may be other types of hardware devices for processing digital information without departing from the invention.

In one or more embodiments of the invention, the security assessment computing resources (240) are hardware devices that are used by the administrative client. The security assessment device resources (240) are accessed locally (e.g., by the applications (220)) or externally (e.g., by administrative clients (120, FIG. 1)).

In one or more embodiments of the invention, at least a portion of the security assessment computing resources (240) are processors. The processors may be, for example, central processing units (CPUs) (either multi-core or single core), graphics processing units (GPUs), and/or any other types of processors without departing from the invention.

In one or more embodiments of the invention, at least a portion of the security assessment computing resources (240) are memory devices. The memory devices may be, for example, random access memory (RAM), read-only memory (ROM), flash memory, and/or any other types of memory without departing from the invention.

In one or more embodiments of the invention, at least a portion of the security assessment computing resources (240) are persistent storage. The persistent storage may be, for example, a solid state drive (SSD), hard-disk drives, and/or any other types of persistent storage without departing from the invention.

In one or more embodiments of the invention, at least a portion of the security assessment computing resources (240) are network resources. In one or more embodiments of the invention, a network resource is a resource used to enable communication between a security assessment devices (e.g., 200) and administrative clients. The network resources may include, for example, a network interface card, a line card, an Ethernet port, a fiber optic cable with optical transceivers, a line card, and/or any other network devices, or portions thereof, without departing from the invention.

The invention may be implemented using other security assessment device resources without departing from the invention.

FIGS. 3A-3B show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIGS. 3A-3B may be performed in parallel with any other steps shown in FIGS. 3A-3B without departing from the scope of the invention.

FIG. 3A shows a flowchart for servicing physical asset security assessment requests in accordance with one or more embodiments of the invention. The method shown in FIG. 3A may be performed by, for example, a security assessment coordination manager (140, FIG. 1). Other components of the system illustrated in FIG. 1 may perform the method of FIG. 3A without departing from the invention.

Turning to FIG. 3A, in step 300, a physical asset security assessment request is obtained. In one or more embodiments of the invention, the physical asset security assessment request is obtained from an administrative client associated with the set of physical assets. Alternatively, the physical asset security assessment request is obtained in response to a policy that specifies a schedule for initiating the security assessments on the set of physical assets on a frequent basis.

In step 302, a physical asset initiation request is sent to the administrative client. In one or more embodiments of the invention, the physical asset initiation request specifies obtaining physical asset state information. The physical asset state information may specify characteristics associated with the usage of the physical assets by the administrative client (or other entities utilizing the physical assets).

In step 304, a physical asset response is obtained from the administrative client. The physical asset response may include the requested physical asset state information associated with the physical assets.

In step 306, a security assessment device is allocated from a security assessment pool. In one or more embodiments of the invention, the security assessment device is allocated using a registry managed by the security assessment coordination manager that specifies unused and/or otherwise available security assessment devices. A security assessment device may be selected from the available set of security assessment devices.

In one or more embodiments of the invention, the security assessment device is generated in response to the physical asset security assessment request. The security assessment coordination manager may identify a set of available computing resources and prepare a computing resource manager and an interface for the computing components to generate the security assessment device. The security assessment coordination manager may further install the applications needed to imitate the set of physical assets. The set of computing resources may be identified based on the registry that may further specify available computing resources in the security assessment pool. The set of computing resources is identified using the obtained physical asset state information.

In step 308, a security assessment process request is sent to the allocated security assessment device. In one or more embodiments of the invention, the security assessment process request specifies the obtained physical asset state information. The security assessment process request may further specify physical asset information obtained from a physical asset information repository.

In step 310, a security assessment report is obtained from the security assessment device. In one or more embodiments of the invention, the security assessment report specifies results of tests performed on the security assessment device as a result of the security assessment process implemented on one or more computing resources and/or applications in the security assessment device. The results may specify one or more security details associated with the set of physical assets. The security details may include, for example, flaws, security risks, vulnerabilities in the system, and/or other information associated with the security in the set of physical assets as determined from the security assessment process performed on the security assessment device.

In one or more embodiments of the invention, the security assessment coordination manager initiates a security action based on the results of the security assessment report. The security action may be an action that attempts at improving any vulnerabilities specified by the security details in the security assessment report.

For example, the security assessment report may specify an ethical hacking performed on an encrypted database took a short amount of time to complete. In other words, the encryption algorithm used to encrypt the database is vulnerable and subject to a hacking by a malicious entity. The security action may include increasing the strength of the encryption algorithm used to encrypt the database. The security assessment coordination manager may initiate the security action on the security assessment device and send a second security assessment process request based on the improved encryption algorithm A second security assessment report may be obtained based on the results of an ethical hacking on the newly encrypted database.

In one or more embodiments of the invention, the security assessment coordination manager may iteratively initiate testing of security actions initiated by the security assessment coordination manager until a set of security criteria is met. The set of security criteria may be predetermined by the security assessment coordination manager or, alternatively, specified by the administrative client. Each iteration of the testing may result in a new iteration of the security assessment report.

In step 312, the security assessment report is sent to the administrative client. In one or more embodiments of the invention, the security assessment report is sent as a message, notification, or other form of communication without departing from the invention.

In one or more embodiments of the invention, the security assessment report may further specify one or more recommendations for improving any flaws in the security system of the set of physical assets. The recommendation(s) may be based on an iterative testing performed on the security assessment device based on results from previous iterations of the security assessment report.

FIG. 3B shows a flowchart performing a security assessment process in accordance with one or more embodiments of the invention. The method shown in FIG. 3B may be performed by, for example, a security assessment device (200, FIG. 2). Other components of the system illustrated in FIG. 1 or FIG. 2 may perform the method of FIG. 3B without departing from the invention.

In step 320, a security assessment process request is obtained for a set of physical assets. In one or more embodiments of the invention, the security assessment process request is the security assessment process request sent by the security assessment coordination manager in step 308.

In step 322, a set of computing resources based on the physical asset information and the physical asset state information is identified. In one or more embodiments of the invention, the set of computing resources is identified using the physical asset state information and the physical asset information obtained from the security assessment coordination manager.

For example, the physical asset information may specify the physical assets including a storage array of four persistent storage devices that have a maximum capacity of 200 terabytes (TB) of data. The physical asset information may further specify that the storage array is used by the administrative client to store a database of employee information with an encryption algorithm in place to prevent undesired access to the database. Based on this physical asset information, the security assessment device may identify four persistent storage devices in the security assessment device with a maximum capacity of at least 200 TB of storage.

In step 324, the identified set of computing resources is allocated to a security assessment process. In one or more embodiments of the invention, allocating the identified set includes using a registry to determine whether the

In step 326, the security assessment process is initiated using the allocated set of computing resources. In one or more embodiments of the invention, the security assessment process includes performing the series of tasks on the allocated computing devices and/or any applications installed in the security assessment device. As the series of tasks produce results, the results are stored in the security assessment report. The security assessment report may be compiled in a format readable to a user of the administrative client.

In step 328, the security assessment report is sent to the security assessment coordination manager. In one or more embodiments of the invention, the security assessment report is sent as a message, notification, or other form of communication without departing from the invention.

Example

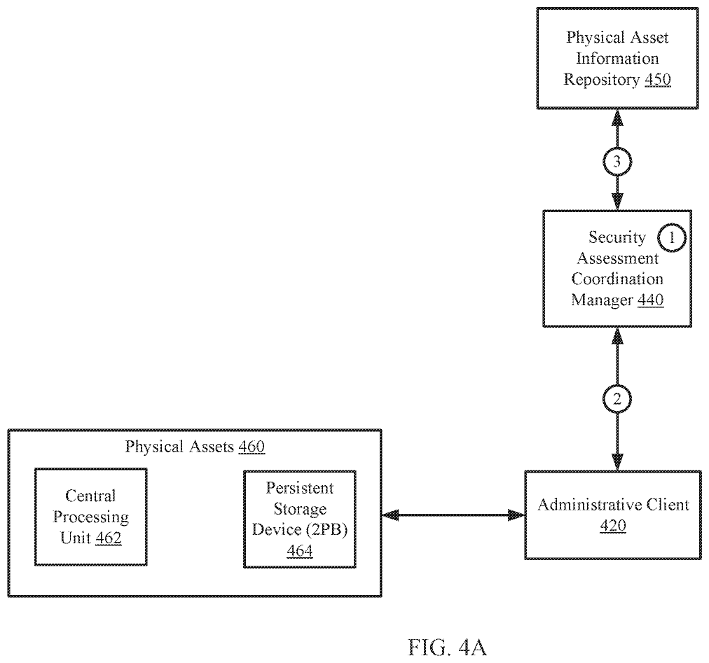

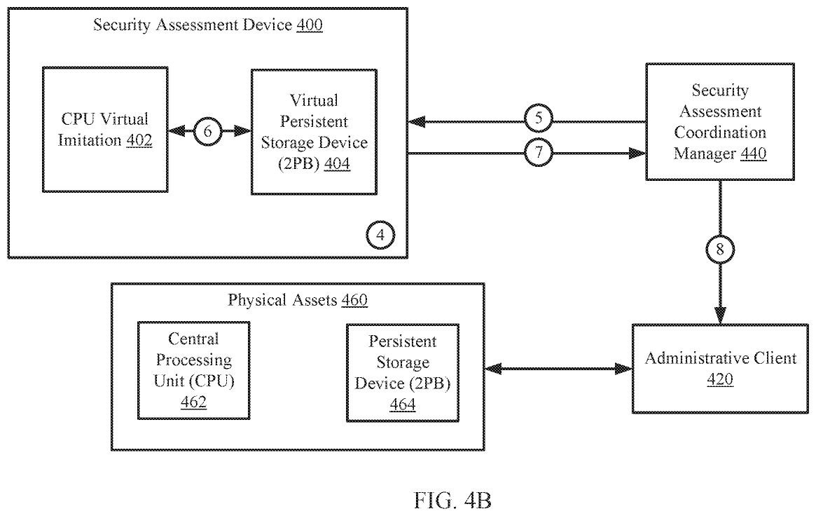

The following section describes an example. The example, illustrated in FIGS. 4A-4B, is not intended to limit the invention. Turning to the example, consider a scenario in which an administrative client has subscribed to a security assessment service provided by a manufacturer of a set of physical assets utilized by the administrative client.

FIG. 4A shows an example system in accordance with one or more embodiments of the invention. For the sake of brevity, not all components of the example system may be illustrated. The example system includes the administrative client (420), a security assessment coordination manager (440), the set of physical assets (460), and a physical asset information repository (450).

The security assessment coordination manager (440), implementing a policy of performing security assessments of the physical assets on a weekly basis, obtains a physical asset security assessment request [1]. The security assessment coordination manager (440), in response to the request, obtains physical asset state information from the administrative client [2]. The physical asset state information specifies the two physical assets (e.g., a CPU (462) and a persistent storage device (464) that includes a maximum capacity of 2 PB) and the amount of data stored in the persistent storage device (464). Further, the physical asset state information specifies an encryption algorithm for storing the data in the persistent storage device (464) and the encryption key. After obtaining the requested physical asset state information, the security assessment coordination manager (440) accesses the physical asset information repository (450) to obtain additional physical asset information not known by the administrative client (420) [3]. The additional physical asset information may specify the version of the firmware (which cannot be modified by the administrative client (420)) installed into the physical assets (460).

Based on the obtained physical asset information from the physical asset information repository (450) and the physical asset state information obtained from the administrative client (420), the security assessment coordination manager (440) includes sufficient information to perform the security assessment process.

FIG. 4B shows a second diagram of the system at a later point in time. At the later point in time, the security assessment coordination manager (440) generates a security assessment device (400) [4]. Specifically, the security assessment coordination manager (440) identifies an available virtual imitation CPU (402) and an available virtual persistent storage device (404) in a security assessment pool (not shown) and reserves the components for the security assessment process. The security assessment device (400) is prepared by installing the identified version of the firmware into the persistent storage device (404).

The security assessment coordination manager (440) sends a security assessment process request to the security assessment device (400) that specifies performing a network penetration test and an encryption hacking of the CPU virtual imitation (402) and the virtual persistent storage device (404) in the security assessment device (400) without using the encryption key [5]. The security assessment device (400), in response to the security assessment process request, initiates the security assessment process [6]. The security assessment process may be performed on the security assessment device (400) without impeding on the use of the physical assets (460) by the administrative client (420).

The results of the penetration test and encryption hacking specify a time it took for the hacking to result in access to the data in the persistent storage device (404). The results may be stored in a security assessment report. The security assessment report may be sent to the security assessment coordination manager (440). The security assessment coordination manager (440) may forward the security assessment report to the administrative client (420).

While not shown in FIGS. 4A-4B, the administrative client (420) may use the results of the security assessment report to further improve the encryption algorithm of the data stored in the persistent storage device (464).

End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention improve the security measurements and assessments of various on-premise physical asset environments without interrupting the operation of such physical asset environments. Embodiments of the invention may utilize information provided by the administrative clients utilizing the physical asset environments in addition to local physical asset information that may not be known by the administrative clients or by any third-party entities providing similar security testing.

Embodiments of the invention may enable the administrative client to continue to utilize the computing resources of the security assessment while the security assessment process is performed on the security assessment device. In this mariner, the security assessment process may be as involved or as intensive as desired without impeding the operation of the physical assets for which the security assessment process assesses.

Further, embodiments of the invention include using machine learning to determine the computing resources that may be best provided to the administrative client based on the utilization of the security assessment device and previous orders of physical assets.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing computing resources, the method comprising:
obtaining, by a security assessment coordination manager, a physical asset security assessment request for a set of physical assets; and
in response to the physical asset security assessment request:
sending a physical asset initiation request to an administrative client;
obtaining a physical asset response from the administrative client, wherein the physical asset response comprises physical asset state information;
allocating a security assessment device from a security assessment pool based on the physical asset state information;
sending a security assessment process request to the security assessment device, wherein the security assessment process request comprises a security assessment process, the physical asset state information and physical asset information obtained from a physical asset information repository;
obtaining a security assessment report from the security assessment device; and
after obtaining the security assessment report, sending the security assessment report to the administrative client, wherein the administrative client initiates a security action on at least a physical asset of the set of physical assets based on the security assessment report.

2. The method of claim 1, wherein the physical asset security assessment request is obtained from the administrative client.

3. The method of claim 1, wherein the physical asset security assessment request is obtained in response to a policy implemented by the security assessment coordination manager.

4. The method of claim 1, wherein the allocating the security assessment device comprises:
identifying a set of computing resources relating to the set of physical assets specified in the physical asset state information; and
installing an application to the set of computing resources relating to the set of physical assets specified in the physical asset state information.

5. The method of claim 1, wherein the security assessment process comprises at least one of: a penetration test, a data packet management test, a network access test, a security scanning, and an application auditing.

6. The method of claim 1, wherein the physical asset information repository is updated by a manufacturer of the set of physical assets.

7. The method of claim 1, wherein the security assessment report specifies a set of security details associated with the set of physical assets.

8. A non-transitory computer readable medium comprising computer readable program code, which when executed by a computer processor enables the computer processor to perform a method, the method comprising:
obtaining, by a security assessment coordination manager, a physical asset security assessment request for a set of physical assets; and
in response to the physical asset security assessment request:
sending a physical asset initiation request to an administrative client;
obtaining a physical asset response from the administrative client, wherein the physical asset response comprises physical asset state information;
allocating a security assessment device from a security assessment pool based on the physical asset state information;
sending a security assessment process request to the security assessment device, wherein the security assessment process request comprises a security assessment process, the physical asset state information and physical asset information obtained from a physical asset information repository;
obtaining a security assessment report from the security assessment device; and
after obtaining the security assessment report, sending the security assessment report to the administrative client, wherein the administrative client initiates a security action on at least a physical asset of the set of physical assets based on the security assessment report.

9. The non-transitory computer readable medium of claim 8, wherein the physical asset security assessment request is obtained from the administrative client.

10. The non-transitory computer readable medium of claim 8, wherein the physical asset security assessment request is obtained in response to a policy implemented by the security assessment coordination manager.

11. The non-transitory computer readable medium of claim 8, wherein the allocating the security assessment device comprises:
identifying a set of computing resources relating to the set of physical assets specified in the physical asset state information;
installing an application to the set of computing resources relating to the set of physical assets specified in the physical asset state information.

12. The non-transitory computer readable medium of claim 8, wherein the security assessment process comprises at least one of: a penetration test, a data packet management test, a network access test, a security scanning, and an application auditing.

13. The non-transitory computer readable medium of claim 8, wherein the physical asset information repository is updated by a manufacturer of the set of physical assets.

14. The non-transitory computer readable medium of claim 8, wherein the security assessment report specifies a set of security details associated with the set of physical assets.

15. A system comprising:
a processor; and
memory comprising instructions which, when executed by the processor, perform a method, the method comprising:
obtaining, by a security assessment coordination manager, a physical asset security assessment request for a set of physical assets; and
in response to the physical asset security assessment request:
sending a physical asset initiation request to an administrative client;
obtaining a physical asset response from the administrative client, wherein the physical asset response comprises physical asset state information;
allocating a security assessment device from a security assessment pool based on the physical asset state information;
sending a security assessment process request to the security assessment device, wherein the security assessment process request comprises a security assessment process, the physical asset state information and physical asset information obtained from a physical asset information repository;
obtaining a security assessment report from the security assessment device; and
after obtaining the security assessment report, sending the security assessment report to the administrative client, wherein the administrative client initiates a security action on at least a physical asset of the set of physical assets based on the security assessment report.

16. The system of claim 15, wherein the physical asset security assessment request is obtained from the administrative client.

17. The system of claim 15, wherein the physical asset security assessment request is obtained in response to a policy implemented by the security assessment coordination manager.

18. The system of claim 15, wherein the allocating the security assessment device comprises:
identifying a set of computing resources relating to the set of physical assets specified in the physical asset state information; and
installing an application to the set of computing resources relating to the set of physical assets specified in the physical asset state information.

19. The system of claim 15, wherein the security assessment process comprises at least one of: a penetration test, a data packet management test, a network access test, a security scanning, and an application auditing.

20. The system of claim 15, wherein the physical asset information repository is updated by a manufacturer of the set of physical assets.
